(19) United States
(12) Patent Application Publication
(10) Pub. No.: US 2002/0017047 A1
(43) Pub. Date: Feb. 14, 2002

(54) Bird decoy

(76) Inventor: Craig A. Mierau, Grand Island, NE (US)

Correspondence Address: ZARLEY MCKEE THOMTE VOORHEES & SEASE PLC, SUITE 3200, 801 GRAND AVENUE, DES MOINES, IA, 50309-2721, US

(21) Appl. No.: 09/903,485

(22) Filed: Jul. 11, 2001

Related U.S. Application Data
(63) Continuation-in-part of application No. 09/631,644, filed on Aug. 2, 2000.

(51) Int. Cl. A01M 31/06

(52) U.S. Cl. 43/3

(57) ABSTRACT

A bird decoy is disclosed comprising a body frame having a wing frame and a plurality of different neck frames which are selectively removably secured to the body frame. The frames are comprised of flexible steel banding material that allows the body, neck, and wings to move independently with, and in response to, the wind. Each frame is covered by a separate sock, which is comprised of a fabric material imprinted with the feather patterns and colorings of a selected species of bird. Feet, comprising flexible strips of metal, are coupled to the body of the decoy and selectively positioned according to the desired decoy pose. A stake is inserted upwardly through the body of the decoy and is secured to the body frame to support the decoy in various positions.

### CROSS-REFERENCE TO RELATED APPLICATION

This is a continuation-in-part application of Petitioner's earlier application Ser. No. 09/631,644 filed Aug. 2, 2000, entitled “A GOOSE DECOY”.

### BACKGROUND OF THE INVENTION

1. FIELD OF THE INVENTION

This invention relates to a bird decoy and more particularly to a decoy shaped to resemble one of a goose, duck, or other bird, having a “spring-like” frame so that the decoy moves with the wind to mimic lifelike bird movement.

2. DESCRIPTION OF THE RELATED ART

Many types of decoys, resembling many different species of birds, have been previously designed. Some of the prior art decoys are “full-bodied” which makes them difficult to transport from one location to another due to the bulk thereof. Other types of prior art decoys have been provided which are comprised of flat, rigid panels, but those types of decoys lack the necessary realistic appearance of a live bird. Such prior art decoys typically do not have the ability to employ interchangeable heads so that the decoy spread may have birds in the sentry position, feeding position, dozer position, etc. Additionally, many prior art decoys lack the strength and durability needed for use in the field.

In the co-pending application, a decoy is disclosed which solves the above-enumerated problems. However, the decoy of co-pending application and those of the prior art further lack selectively positionable and removable wings that are capable of reacting to the wind to mimic lifelike movement. The invention disclosed herein represents an improvement over the invention of the co-pending application and remaining prior art through, among other novel and inventive improvements, the incorporation of such selectively positionable and removable wings.

### SUMMARY OF THE INVENTION

A decoy is disclosed which closely resembles one of many different species of birds, such as geese, ducks, and other birds. The decoy is constructed such that it is easily transported and assembled. The decoy includes a substantially vertically disposed body frame consisting of an elongated, flat, flexible band member. The body frame is formed to define a tail portion, a back portion, a breast portion, and an abdomen portion. A fabric cover, or sock, removably encloses the body frame. The sock is imprinted with the body coloring of the selected species of bird.

A head frame is selectively removably secured to the body frame adjacent the breast portion and the back portion of the body frame. The head frame may take various shapes such as a 90° feeder, 45° feeder, drinking, dozer, sentry, talking, and sleeping. The head frame is further adapted to be selectively moved between right-looking and left-looking positions. A fabric cover, or sock, removably encloses the head frame and is imprinted with the neck and head markings of the selected species of bird.

A wing frame is selectively removably secured to the back portion of the body frame using a mounting assembly which allows the wings to pivot about an axis substantially parallel to the longitudinal axis of the body frame. The independent movement of the wings with respect to the body mimics a number of “flight” and “landing” wing movements. The wing frame is hinged at a plurality of locations to selectively angle or bend the wings according to the desired decoy position. A fabric cover, or sock, removably encloses the head frame and is imprinted with the characteristic wing markings of the selected species of bird.

An elongated stake is removably secured to the body frame for insertion into the ground to support the body frame. The design of the stake is adapted to prevent the stake from rotating in the ground and with respect to the decoy. Feet may also be removably secured to the body frame adjacent the stake for further improvement to the decoy's appearance.

When the wind blows, the band member of the body frame and wings react thereto to create movement in body and wings of the decoy, thereby simulating a lifelike appearance. The head frame reacts to the wind to create a bobbing effect for the head of the decoy. The fabric socks also react to wind, creating a feather-like movement on the decoy.

It is therefore a principal object of the invention to provide an improved bird decoy.

A further object of the invention is to provide an improved bird decoy which closely resembles one of several species of birds including at least geese and ducks.

A further object of the invention is to provide a bird decoy that moves with, and reacts to, the wind.

Yet another object of the invention is to provide a bird decoy which maintains its position even in high winds.

A further object of the invention is to provide a bird decoy that utilizes fabric to provide flexibility to the body, somewhat like feather movement.

Still another object of the invention is to provide a decoy where different species of body socks may be mounted on the body frame.

A further object of the invention is to provide a bird decoy having detachable and selectively positionable wings.

Another object of the invention is to provide a bird decoy having wings which freely move with, and react to, the wind.

Yet another object of the invention is to provide a bird decoy whereby the body and head position may be easily changed.

Still another object of the invention is to provide a bird decoy which is easily transportable in either the unassembled or partially assembled condition.

Yet another object of the invention is to provide a bird decoy which is easily stored.

Yet another object of the invention is to provide a bird decoy wherein ice and snow buildup is easily removed.

These and other objects will be apparent to those skilled in the art.

### BRIEF DESCRIPTION OF THE DRAWINGS

FIG. 1 is a perspective view of the bird decoy of this invention;

FIG. 2 is a perspective view of the framework, supporting stake, and feet of the bird decoy;

FIG. 3 is a perspective view of the head and body socks;

FIG. 4 is a partial perspective view illustrating portions of the framework and supporting stake;

FIG. 5A is a perspective view of the head frame of the sentry bird decoy;

FIG. 5B is a perspective view of the head frame of a dozer bird decoy;

FIG. 5C is a view similar to FIG. 5A except that the mounting means provides somewhat more movement to the head frame;

FIG. 5D is a perspective view of a feeding bird decoy;

FIG. 5E is a perspective view of the head frame of a talking bird decoy;

FIG. 5F is a perspective view of the head frame of a right-looking bird decoy;

FIG. 5G is a perspective view of the head frame of a left-looking bird decoy;

FIG. 5H is a perspective view of the head frame of a dozer bird decoy which is selectively pivotally moved between right-looking and left-looking positions;

FIG. 6 is a perspective view of the bird decoy of the present invention with a pair of wings secured in an upper extended position;

FIG. 7 is a perspective view of the bird decoy of the present invention with a pair of wings secured in a lower extended position;

FIG. 8 is a front view of the bird decoy of the present invention depicting the side-to-side pivoting motion of the decoy's wings;

FIG. 9 is a perspective view of the wing frame assembly of the present invention in a disassembled position;

FIG. 10 is a perspective view of the bird decoy of the present invention in a disassembled position; and

FIG. 11 is a perspective view of the pin and bracket assembly that joins the wing frame assembly of the present invention.

### DESCRIPTION OF THE PREFERRED EMBODIMENT

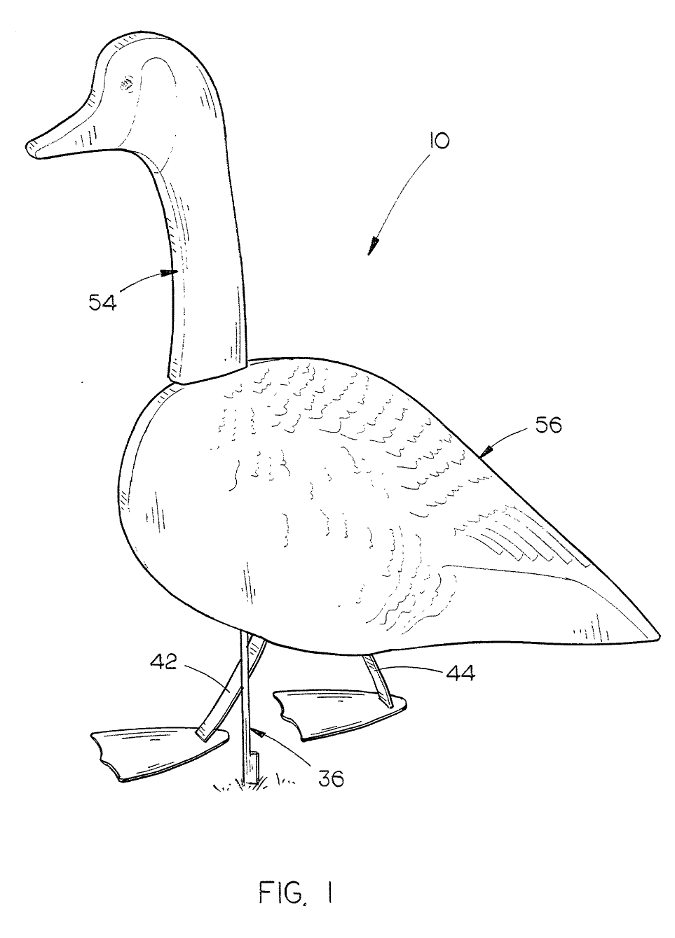

The bird decoy of this invention is referred to generally by the reference numeral 10. For simplicity of description only, the bird decoy 10 of the present invention will be described as the same is configured to closely resemble a goose. It is contemplated that the structures described herein, and the methods of assembling the same, are equally applicable to decoys resembling geese, ducks, turkeys, pheasants, quail, and nearly any other species of bird. FIG. 1 illustrates an assembled goose decoy with a “sentry” head mounted thereon, as will be described in greater detail hereinafter. FIG. 1 also illustrates the decoy with optional feet, as will also be described in more detail hereinafter.

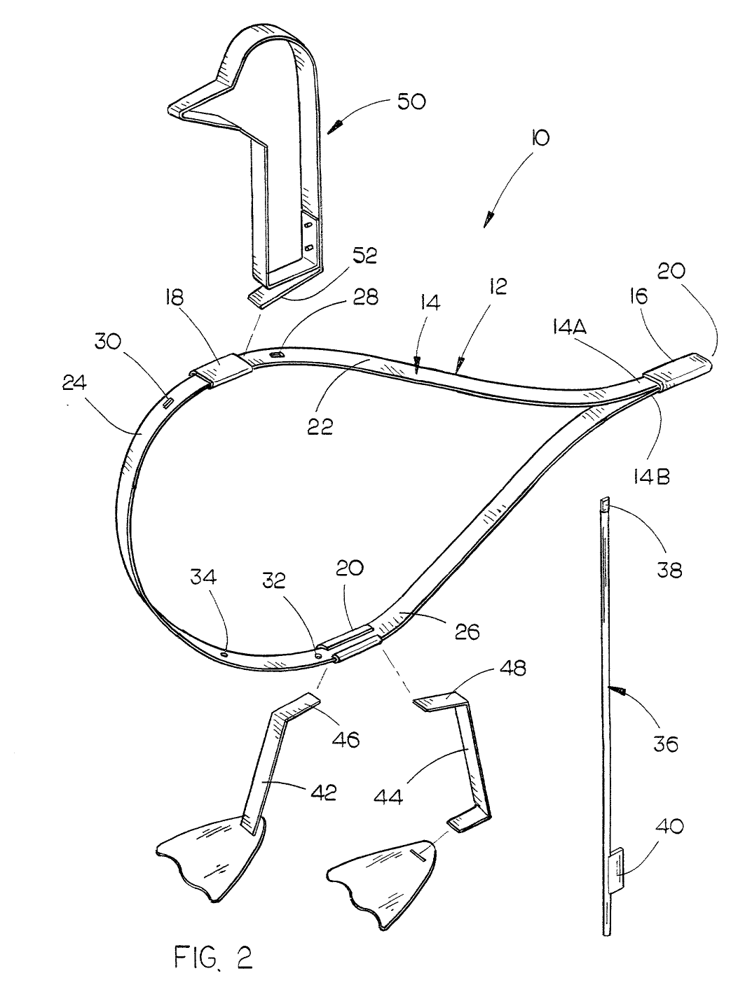

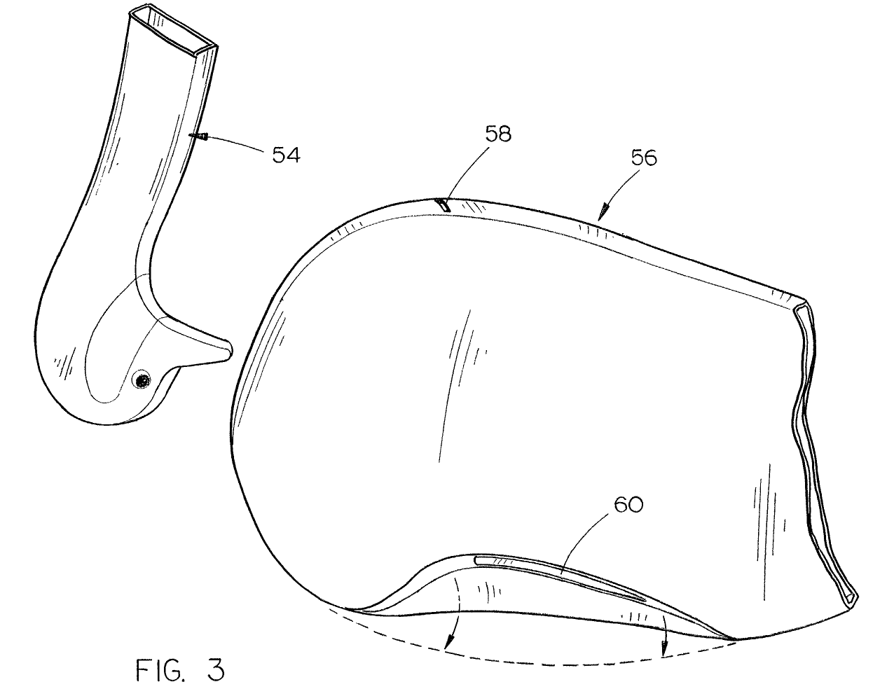

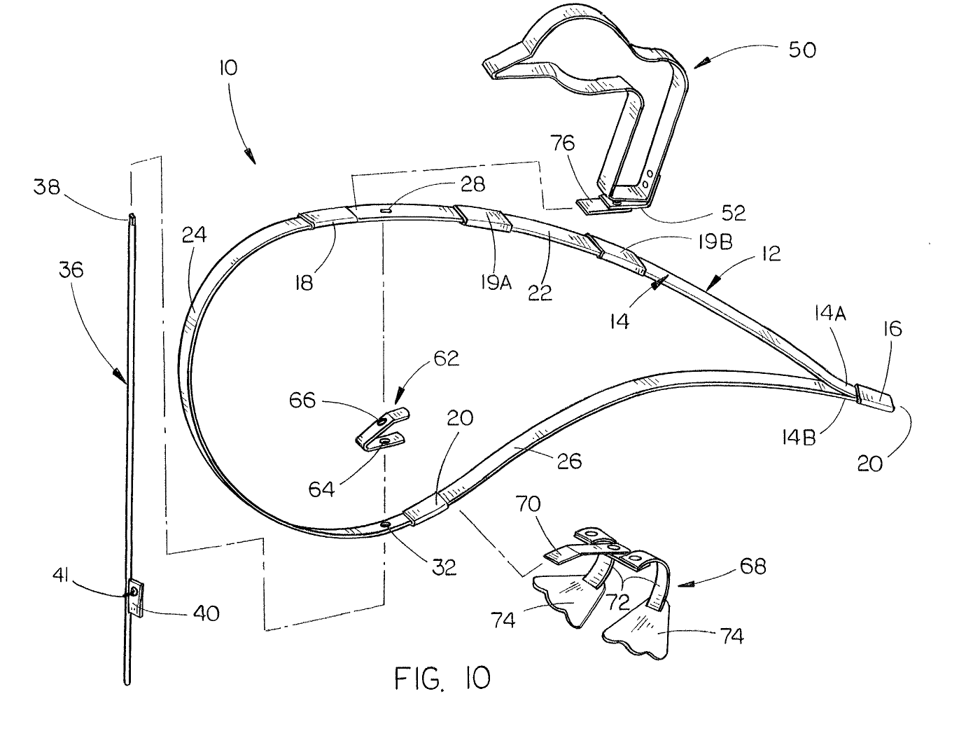

Decoy 10 includes a body frame 12 which is comprised of a flexible, flat band member 14 which is preferably comprised of ¾ inch wide steel banding material with an approximate thickness of 0.020 inches. For purposes of description, band 14 will be described as comprising ends 14A and 14B. Clip 16 is clipped onto the end of end 14A of band 14 and is adapted to have end 14B frictionally and removably received therein to maintain the body frame 12 in the position illustrated in FIG. 2. A head clip 18 is selectively slidably mounted on band member 14, as seen in the drawings. If the optional wings for the decoy are to be used, clips 19A and 19B are selectively slidably mounted on band member 14, as seen in FIG. 10. If the optional feet for the decoy are to be used, a clip 20 is selectively slidably mounted on band member 14, as seen in FIG. 2.

When end 14B is received in clip 16, as illustrated in FIG. 2, the body frame 12 defines a tail portion 20, back portion 22, breast portion 24, and abdomen portion 26. A pair of spaced-apart rectangular openings 28 and 30 are formed in band member 14, as seen in FIG. 2, and a pair of circular openings 32 and 34 are formed in band member 14, as also seen in FIG. 2. The numeral 36 refers to a stake having a rectangular portion 38 at its upper end and a baffle 40 adjacent its lower end. Stake 36 may be extended upwardly through opening 32 so that end 38 is received in opening 28 to maintain the body frame 12 in a substantially vertically disposed position. Stake 36 may also be extended upwardly through opening 34 so that end 38 may be received in opening 30 to vary the attitude of the body frame as desired.

A V-shaped clip 62 is provided to prevent the stake 36 from exiting downwardly through opening 32. Clip 62 is preferably formed from an elongated piece of resilient material, such as metal or plastic. Openings 64 and 66 are formed adjacent the opposite ends of the piece of material. A generally acute angle is then formed into the piece of material between openings 64 and 66. After the stake 36 has been extended through opening 32 of the body frame, slight inward pressure is exerted on the opposite ends of clip 62 until openings 64 and 66 are sufficiently aligned to allow stake 36 to extend through both openings. Once end 38 of stake 36 is secured within opening 28, slight inward pressure is again exerted on the opposite ends of clip 36 so that it can be easily slid along the length of stake 36 until it is positioned closely adjacent opening 32. The pressure being applied to the opposite ends of the clip is then released, causing clip 62 to exert an outward spring force against stake 36 and lock clip 62 into place.

When the stake 36 is inserted into the ground, as shown in FIG. 1, a baffle 40, disposed at the lower end of stake 36, prevents the stake 36 from being rotated with respect to the ground. A generally planar, rectangular baffle 40 is preferred due to its ease of manufacture. However, any conceivable shape will suffice, so long as it is thin enough to be easily inserted into the ground and wide and long enough to sufficiently engage the ground and resist a turning force being applied to stake 36. Additionally, an opening 41 can be formed in baffle 40 so that an elongated object, such as a screwdriver, can be extended therethrough to help remove the stake 36 from ground that has become frozen. When the rectangular portion 38 of stake 36 is extended through rectangular openings 28 or 30, the body frame 12 is prevented from being rotated with respect to stake 36 due to wind engagement therewith.

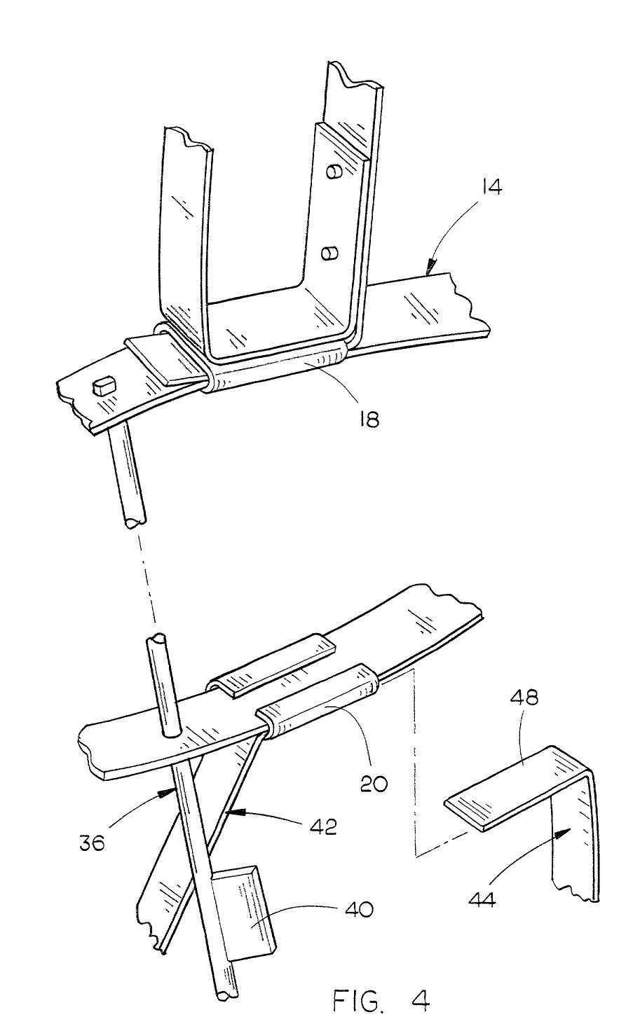

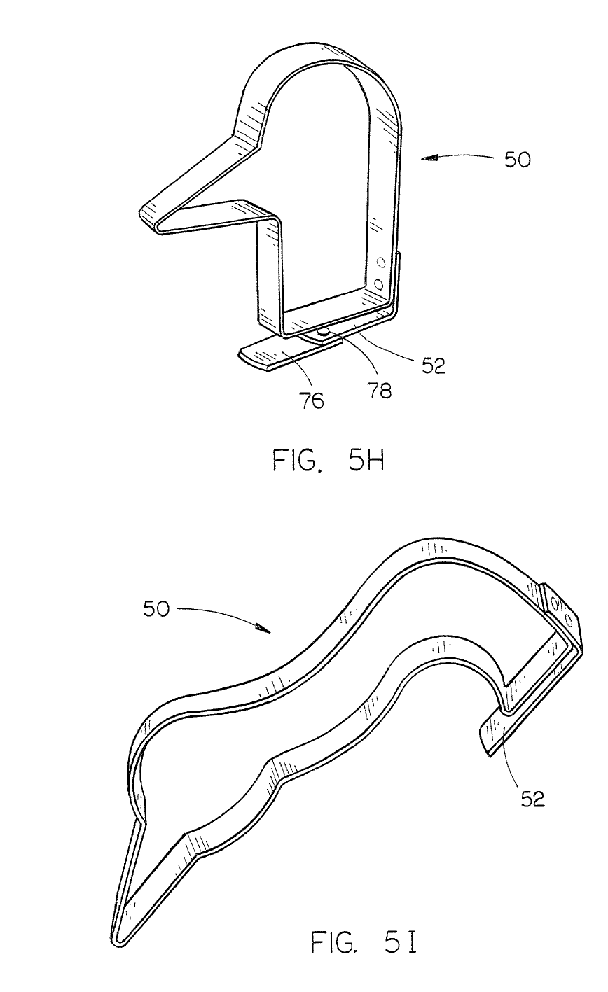

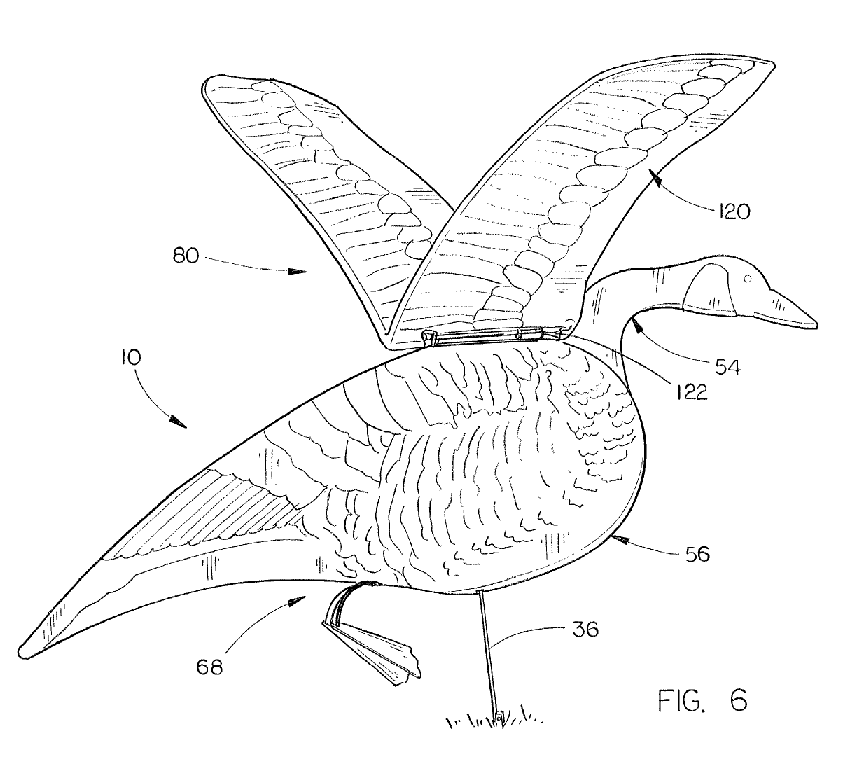

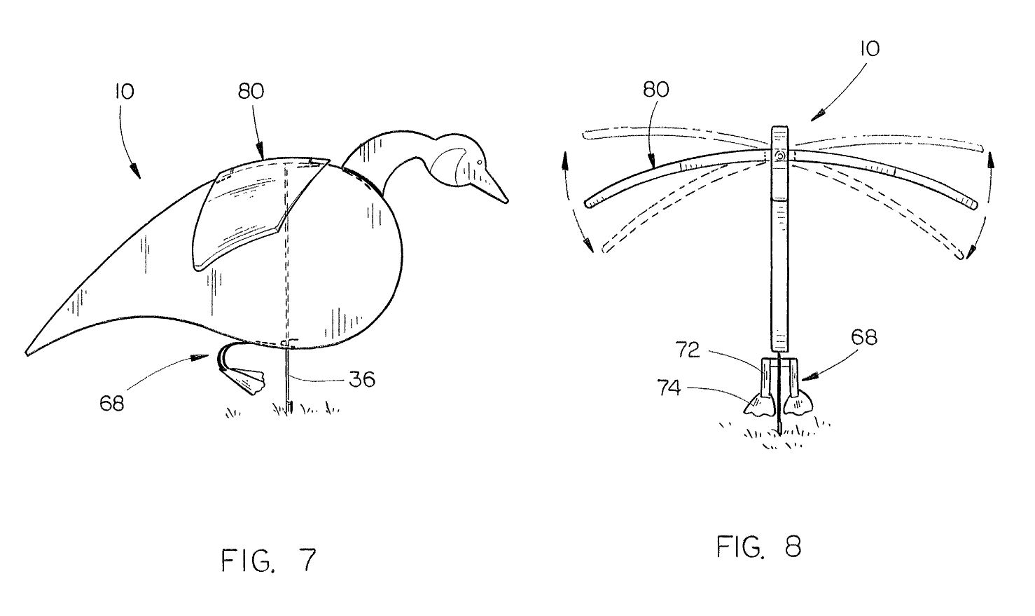

A pair of optional feet 42 and 44 may be mounted on the body frame 12 by inserting the upper ends 46 and 48 thereof, respectively, into the forward and rearward ends of the clip 20, as illustrated in FIGS. 2 and 4. In an alternate embodiment, a second pair of optional feet 68 may be mounted on the body frame 12 by inserting the upper end 70 thereof onto the rearward end of clip 20, as illustrated in FIGS. 6-8 and 10. In either embodiment, however, each individual “leg” 72 and “foot” 74 is removably coupled so that it may be disassembled for substantially flat storage when the decoy 10 is not in use.

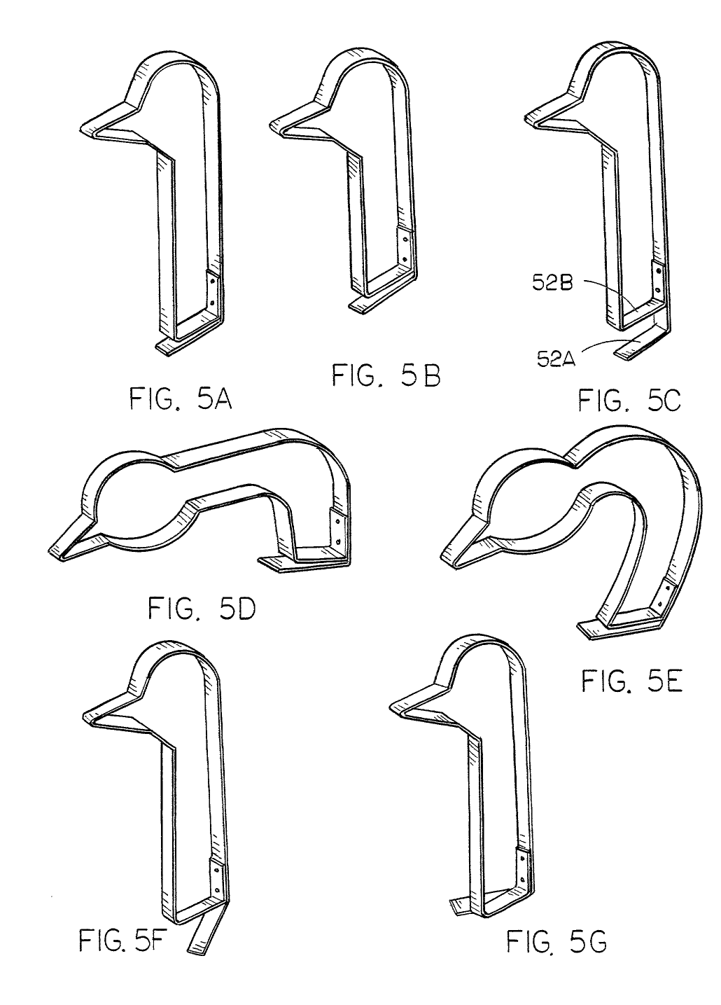

The numeral 50 refers to a head frame which is also comprised of a band material similar to band member 14 and which is bent to define the neck and head of a goose. Head frame 50 includes a lower end portion 52 which may be slidably inserted between clip 18 and band member 14 to maintain head frame 50 in position. FIGS. 5A-5H illustrate various head frame configurations so that the decoy may be modified to a sentinel decoy, feeding decoy, drinking decoy, dozer decoy, etc. FIG. 5C illustrates a head frame wherein the lower end 52A is spaced a greater distance from the cross member 52B so that the head will have a greater ability to bob in the wind. FIG. 5H illustrates a head frame having an elongated base portion 76, having first and second ends. The first end of base portion 76 is pivotally secured to the lower end portion 52 with a pin or rivet 78 so that the head frame 50 can be selectively pivoted between right-looking and left looking positions. The second end of base portion 76 may be slidably inserted between clip 18 and band member 14 to maintain head frame 50 in position.

An optional wing member 80 may be removably mounted on body frame 12 when flight and landing decoy positions are desired. The wing member 80 is preferably comprised of a band material such as band member 14. Although it is contemplated that wing member 80 could be formed by bending a single piece of band material, it is preferred, for functional and structural reasons discussed below, that a plurality of band members be used to form a separate right wing 82 and left wing 84. The right wing 82 and left wing 84 are similarly constructed. Accordingly, only the construction of the right wing will be discussed.

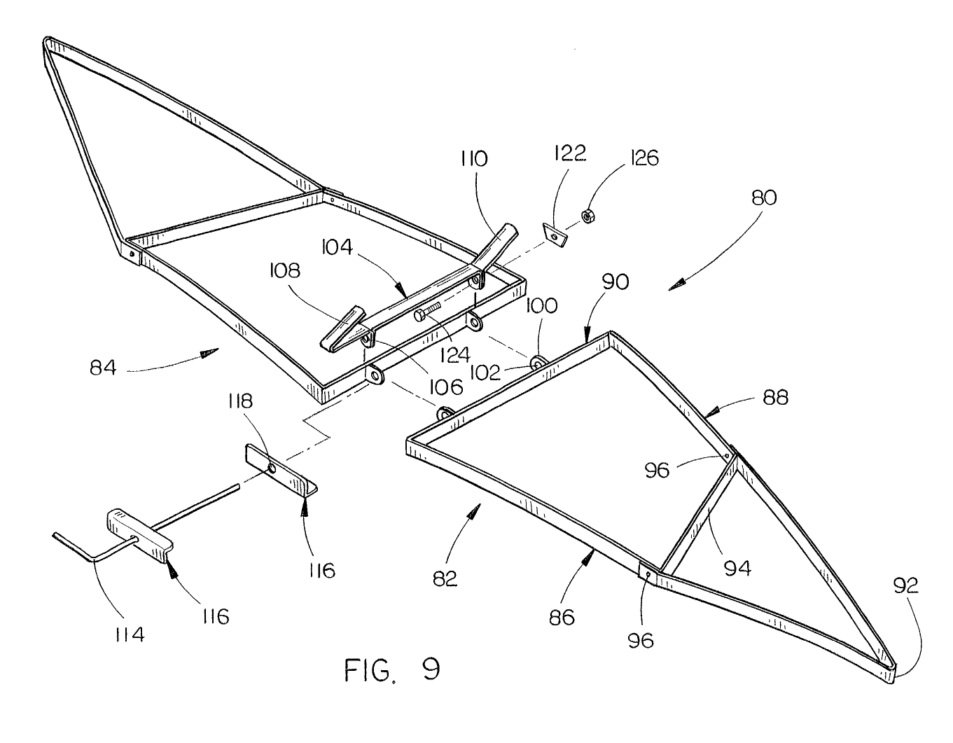

The right wing 82 is generally formed to define a leading edge 86, a trailing edge 88, a base portion 90, and a wing tip 92. The right wing is preferably formed from two elongated strips of banding material. The first strip is formed into the shape of a triangle, which forms the outer half of right wing 82 and terminates at wing tip 92. The side of the triangle opposite wing tip 92 forms wing brace 94. The second strip of banding material is formed into a U-shape. The two free ends of the U-shape are pivotally secured to the opposite ends of wing brace 94 using pins or rivets, which form hinge 96. The base of the U-shape forms base portion 90. In this configuration, brace 94 and base edge 90 provide the right wing 82 with the torsional stability needed when the decoy 10 is used in windy conditions. Hinge 96 allows the wing tips 92 to be moved between generally horizontal and angled wing positions. FIG. 9 illustrates the right wing 82 in a generally horizontal position and left wing 84 in a slightly angled position.

Mounting assembly 98 is provided to removably couple right wing 82 to left wing 84 and removably secure the wing member 80 to the body frame 12. At lest one tab 100 extends outwardly from the base portion 90 of both right wing 82 and left wing 84. An opening 102 is formed in each tab 100. The tabs 100 on right wing 82 and left wing 84 are arranged such that, when the base portions 90 of the two wings are placed closely adjacent one another, the openings 102 become aligned with one another.

Mounting bracket 104 is provided to secure wing member 80 to body frame 12. Mounting bracket 104 is preferably comprised of a band material similar to band member 14. The band material is bent or otherwise formed to create at least one tab 106, a forward end 108, and a rearward end 110. An opening 112 is formed within tab 106 so that, when the mounting bracket 104 is positioned closely adjacent the base portions 90 of the right wing 82 and left wing 84, openings 112 and 102 are aligned with one another. Openings 112 and 102 are formed with sufficient diameter to receive a mounting pin 114 therethrough to pivotally connect the mounting assembly 98 to wing member 80. The forward end 108 may be slidably inserted between clip 19A and band member 14 and the rearward end 110 may also be slidably inserted between clip 19B and band member 14 to maintain wing member 80 in position on the back portion 22 of body frame 12.

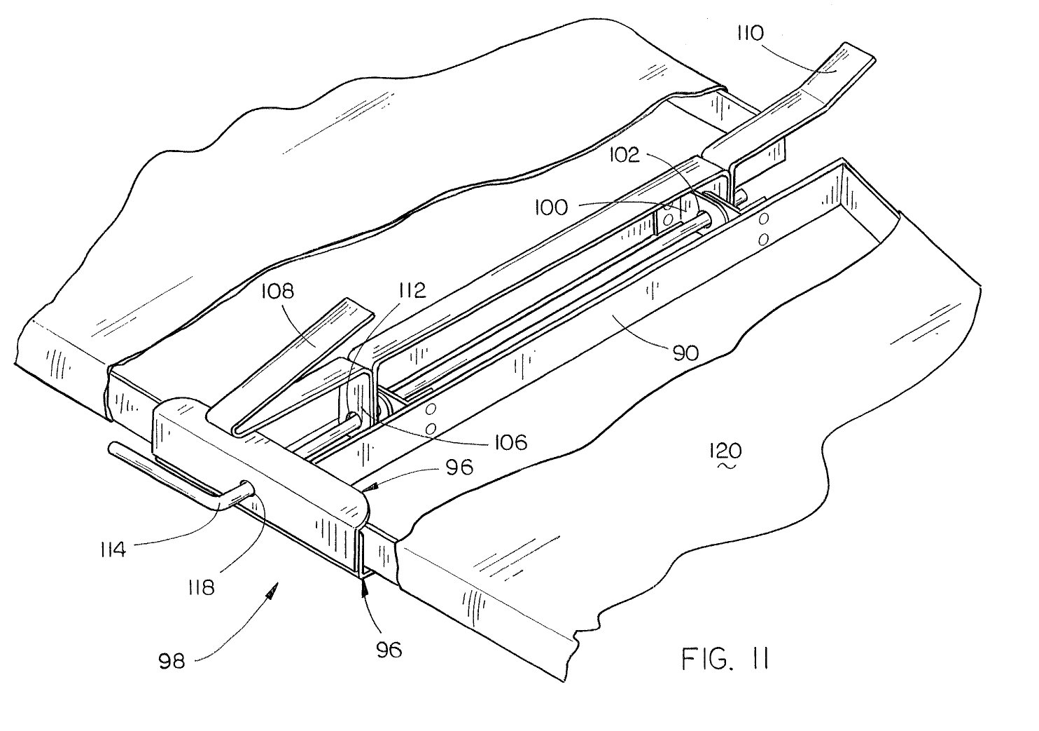

An elongated bracket 116 is provided to restrict the pivoting motion of the right wing 82 and left wing 84 with respect to one another. Bracket 116 is generally characterized as having first and second ends, a generally horizontally disposed surface, and a generally vertically disposed surface, forming a generally L-shaped cross section. An opening 118 is formed in the vertical surface of bracket 116, intermediate the first and second ends thereof. In use, bracket 116 is placed closely adjacent the leading edge 86 of the wing member 80 so that opening 118 is disposed along the same longitudinal axis as openings 102 and 112. The horizontal surface of bracket 116 is selectively placed above or below leading edge 86 to restrict the pivoting motion of the right wing 82 and left wing 84 with respect to one another. When the horizontal surface of bracket 116 is placed above the leading edge 86, the upper pivoting motion is restricted. Similarly, when the horizontal surface of bracket 116 is placed below the leading edge 86, the lower pivoting motion is restricted. As shown in FIGS. 9 and 11, two brackets 116 can be used simultaneously, in alternating upper and lower positions, to restrict the pivoting motion of the right wing 82 and left wing 84 with respect to one another in either direction.

Bracket 116 can also be formed so that both the horizontal surface and the vertical surface become generally V-shaped (not shown). Two V-shaped brackets can be used in simultaneous alternating positions to fix the wing member 80 in an upper angled position, illustrated in FIG. 6, or a lower angled position (not shown). By removing one V-shaped bracket, the pivoting motion of wing member 80 can be selectively freed in one direction. This arrangement allows the right wing 82 and left wing 84 to move in a “flapping” motion when the wing member is engaged by the wind.

The numeral 54 refers to a fabric sock preferably comprised of a 50-50 polyester-cotton mixture which is screen printed with the head and neck colorings of a goose. Sock 54 is slipped over the head frame 50 with the lower end portion 52 protruding from the lower end of the sock to enable the lower end portion 52 to be secured to the clip 18. The numeral 56 refers to a body sock which embraces the body frame 12, as will be described hereinafter. The numeral 120 refers to a wing sock which embraces the wing frame 80, as will be described hereinafter. Body socks 56 and 120 are also preferably constructed of a 50-50 polyester-cotton mixture which has been screen printed with the details of the body and wings of the particular species of bird desired.

The upper end of body sock 56 is provided with a slit 58 which will be positioned over the clip 18 to enable the lower end portion 52 of head frame 50 to be inserted through the slit 58 for insertion into the clip 18. Normally, the slit 58 will be created by the individual hunter to enable the hunter to position head frame 50 as he/she desires. Body sock 56 is also provided with an elongated opening 60 at the lower end thereof to enable the feet 42 and 44 to be inserted therethrough, if the feet are utilized, and to enable the stake 36 to be inserted upwardly therethrough for engagement with the body frame 12.

When the decoy 10 is disassembled, the body frame 12 may be either stored in the position illustrated in FIGS. 2 or 10, or the end 14B may be removed from the clip 16 so that the band member 14 will be in a substantially flat position for storage. The various components are taken to the field in either a disassembled or partially assembled condition. Assuming that the decoy is completely disassembled, the first step in the assembly of the goose decoy will be to bend the band member 14 to the position of FIG. 2 so that the end 14B is received by clip 16 to maintain the band member 14 in the shape illustrated in FIG. 2. The band member 14 is then grasped by the hunter near the tail end thereof to move the upper and lower portions of the band member towards one another so that the body frame 12 may be inserted into the interior of the body sock 56 through the opening 60. Once the tail portion 20 of the body frame 12 is received by the tail portion of the body sock 56, the body frame 12 is “rolled” into the interior of the body sock 56 so that the body sock 56 will assume the shape illustrated in FIG. 1.

Right wing 82 and left wing 84 are disposed within wing sock 120, through opening 122, one wing at a time. Mounting bracket 104 is simultaneously secured to right wing 82 and left wing 84 by mounting pin 114. Depending on the desired wing motion, one or more brackets 116 can be incorporated within the mounting assembly 98 prior to the insertion of mounting pin 114 through mounting bracket 104, right wing 82, and left wing 84. The forward end 108 of mounting bracket 104 is inserted between clip 19 and band member 14 and the rearward end 110 may also be slidably inserted between clip 19B and band member 14 to removably secure wing member 80 to the back portion 22 of body frame 12.

Any one of the head frames illustrated in the drawings, having a head sock 54 received thereon, may then be secured to the body frame 12 by inserting the lower end portion 52 of the head frame 50 through the slit 58 for connection to the clip 18. The stake 36 may then be inserted upwardly through the opening 60 for connection to the body frame 12. If feet are being used on the decoy, they also would be partially inserted through the opening 60 for connection to the clip 20.

When the decoy is in place, the wind action thereagainst causes the sock 54, the body sock 56, and wing sock 120 to ripple somewhat, thereby giving the appearance of feather movement on the decoy to enhance the realistic appearance thereof. Further, wind action against the decoy causes the flexible body frame 12 to flex and move, further giving realistic movement to the decoy. Wind action against the head of the decoy causes the head to bob up and down somewhat due to its flexible characteristics and due to its flexible connection to the body frame. The wind also engages wing member 80 causing it to pivot with respect to the body and, depending on the selection of brackets 116, further pivot in a “flapping” motion.

The fact that many different types of necks may be attached to the decoy enables the decoy spread to be varied so that certain of the decoys are sentinels, dozer, feeding, etc. The fact that the fabric covers the frames enables snow and ice to be quickly and easily brushed or removed therefrom. The coloring on the body, wing, and neck socks may be varied for different types of bird species, such as geese, ducks, turkeys, pheasants, quail, and others. The coloring may also be varied for different types of sub-species, such as snow geese, blue geese, etc. The patterns used on the body sock 56 can also be arranged to depict a “feeder” back, a “straight” back, and even wings, when optional wing member 80 is not used.

It is contemplated that any or all of the wing member 80, feet 42 and 44, feet 68, stake 36, head frame 50, sock 54, sock 56, or sock 120, could be operatively secured to the body structure of virtually any prior art decoy to selectively modify the same. For example, the body structure of a traditional, three dimensional decoy made form wood, plastic, or metal, could be adapted with clips similar to clips 19A, 19B, and 20, or other receiving means, to operatively receive and secure the mounting assembly 98 of wing member 80 and feet 68 thereto. However, it is preferred that the body frame 12 be used as the body of the decoy. Its structural characteristics make it inexpensive and easy to assemble, store, and transport. Moreover, the body movement provided by body frame 12, when engaged by the wind, is an additional substantial benefit over prior art decoys.

In the drawings and in the specification, there have been set forth preferred embodiments of the invention and although specific items are employed, these are used in a generic and descriptive sense only and not for purposes of limitation. Changes in the form and proportion of parts, as well as a substitution of equivalents, are contemplated as circumstances may suggest or render expedient without departing from the spirit or scope of the invention as further defined in the following claims.

Thus it can be seen that the invention accomplishes at least all of its stated objectives.

I claim:

1. A bird decoy, comprising:
an elongated body structure having a front end, a back end, an upper end, and a lower end; and
an elongated wing member, having first and second ends;
said wing member being operatively pivotally secured to said body structure, adjacent the upper end thereof, so that said wing member can pivot about an axis which is substantially parallel to the elongated axis of said body structure.

2. The bird decoy of claim 1 further comprising a mounting assembly, having upper and lower ends; said upper end of said mounting assembly being operatively secured to said wing member intermediate the first and second ends thereof; said lower end of said mounting assembly being operatively removably secured to the body structure; said mounting assembly being adapted to permit the wing member to pivot about an axis which is substantially parallel to the elongated axis of said body structure.

3. The bird decoy of claim 1 wherein said wing portion is comprised of an elongated wing frame and a wing cover; said wing frame being selectively removably disposed within said wing cover.

4. The bird decoy of claim 3 wherein said elongated wing frame is comprised of at least one generally elongated flexible band member formed to define a leading edge, a trailing edge, and said first and second ends of said wing member.

5. The bird decoy of claim 3 wherein said wing member is comprised of a right wing frame and a left wing frame; said right and left wing frames each being formed to define a leading edge, a trailing edge, a base edge, and a wing tip.

6. The bird decoy of claim 5 further comprising at least one right wing tab extending outwardly from the base edge of said right wing frame and at least one left wing tab extending outwardly from the base edge of said left wing frame.

7. The bird decoy of claim 6 wherein said at least one right wing tab and said at least one left wing tab have openings disposed therethrough; said openings being adapted to receive a mounting pin to operatively pivotally connect the base edge of said right wing frame to the base edge of said left wing frame.

8. The bird decoy of claim 7 further comprising an elongated mounting bracket having first and second ends, upper and lower ends, and at least one mounting bracket tab extending outwardly from said upper end; said at least one mounting bracket tab being adapted to be positioned closely adjacent said right wing tab and said left wing tab and receive said mounting pin therethrough to operatively pivotally connect the mounting bracket to said wing member.

9. The bird decoy of claim 8 wherein said first and second ends of said mounting bracket are adapted to be operatively secured to said body structure, closely adjacent the upper end thereof.

10. The bird decoy of claim 4 wherein said elongated wing frame is further comprised of at least one support brace extending between said leading edge and said trailing edge.

11. The bird decoy of claim 4 wherein said elongated wing frame is comprised of at least one hinge member formed within said at least one band member so that said wing frame can be selectively moved between generally horizontal and angled wing positions.

12. The bird decoy of claim 7 further comprising at least one elongated bracket operatively secured to said right wing frame and said left wing frame for restricting the pivoting movement of said right wing frame and said left wing frame with respect to one another.

13. The bird decoy of claim 12 wherein said at least one elongated bracket is generally V-shaped to support said right wing frame and said left wing frame in an angled position.

14. The bird decoy of claim 3 wherein said wing cover is comprised of a flexible fabric material forming a pocket, having an interior cavity, exterior surface, bottom portion, and top portion, said bottom portion having an opening formed therein; said exterior surface being adapted to resemble the wing markings of a bird.

15. The bird decoy of claim 14 wherein the said opening in said bottom portion of said cover is adapted to receive said wing frame and allow the same to pass therethrough.

16. The bird decoy of claim 3 further comprising a body cover; said body cover comprising a flexible material forming a pocket, having an interior cavity, exterior surface, top portion, and bottom portion, said bottom portion having an opening formed therein; said exterior surface being adapted to resemble the body markings and plumage of a bird.

17. The bird decoy of claim 16 wherein the opening in said bottom portion of said body cover is adapted to receive said body structure and allow the same to pass therethrough.

18. The bird decoy of claim 1 further comprising at least one leg member selectively removably secured to said body structure.

19. The bird decoy of claim 1 further comprising a head frame selectively adjustably mounted on said body frame; said head frame comprising an elongated, flat band member formed to define a neck portion, a head portion, and a bill or beak portion.

20. The bird decoy of claim 19 further comprising a head cover comprised of a flexible material which is imprinted with the wing markings of a bird; said head cover being adapted to selectively removably enclose said head frame.

21. The bird decoy of claim 19 wherein said head frame is further comprised of an elongated base portion, having first and second ends; said first end being pivotally secured to said neck portion so that said head frame can be selectively moved between right-looking and left-looking positions; said second end being adapted to operatively secure the head frame to said body structure.

22. The bird decoy of claim 19 wherein said head frame is shaped to resemble the head and neck of one of a sentinel bird, a feeding bird, a drinking bird, a dozer bird, or a talking bird.

23. The bird decoy of claim 1 further comprising an elongated stake selectively removably secured to said body structure for insertion into the ground to support said body structure.

24. The bird decoy of claim 23 wherein said stake includes anti-rotation means to prevent rotation of said stake with respect to the ground.

25. The bird decoy of claim 23 wherein said stake includes anti-rotation means to prevent rotation of said body structure with respect to said stake.

26. A bird decoy, comprising:
a substantially vertically disposed body frame comprising an elongated, flexible band member formed to define a tail portion, a back portion, a breast portion, and an abdomen portion;
an elongated stake selectively removably secured to said body frame for insertion into the ground to support said body frame; and
a body frame cover; said body frame cover comprising a generally flexible material forming a pocket, having an interior cavity, an exterior surface, bottom portion, and top portion; said bottom portion having an opening formed therein for removably receiving said body frame; said exterior surface being imprinted with the body markings of a bird.

27. The bird decoy of claim 26 further comprising a wing frame comprising at least one elongated, flexible band member forming a leading edge, a trailing edge, and opposing wing tips; said wing frame being adapted to be selectively removably secured to said body frame adjacent said back portion.

28. The bird decoy of claim 27 further comprising a wing frame cover, said wing frame cover comprising a generally flexible material forming a pocket, having an interior cavity, an exterior surface, a bottom portion, and a top portion; said bottom portion having an opening formed therein for removably receiving said wing frame; said exterior surface being imprinted with the body markings of a bird.
